(19) United States
(12) Patent Application Publication
(10) Pub. No.: US 2026/0099281 A1
(43) Pub. Date: Apr. 9, 2026

(54) MANAGEMENT APPARATUS, METHOD FOR MANAGEMENT APPARATUS, AND RECORDING MEDIUM

(71) Applicant: CANON KABUSHIKI KAISHA, Tokyo (JP)

(72) Inventor: SATOSHI NISHIKAWA, Kanagawa (JP)

(21) Appl. No.: 19/331,507

(22) Filed: Sep. 17, 2025

(30) Foreign Application Priority Data
Oct. 3, 2024 (JP) 2024-174255

(51) Int. Cl. G06F 3/12; H04N 1/00

(52) U.S. Cl. CPC G06F 3/1207; G06F 3/1234; H04N 1/00344; H04N 1/00477; H04N 2201/0094

(57) ABSTRACT

A device management server that manages network devices via a network includes a task management unit that executes a task for a network device that has been selected from among managed devices, and a task display unit that controls display of an execution result of the task, and the task display unit displays, for a task that has ended in error, a detailed screen that displays for each network device, in a list, information indicating the network device that is the target of the task, a type of error, and detailed information of the error.

### BACKGROUND

### Field of the Technology

The present disclosure relates to a management apparatus, a method for the management apparatus, and a recording medium.

### DESCRIPTION OF THE RELATED ART

Conventionally, a device management system for acquiring and managing data such as operations information for an image forming apparatus such as a printer or a multifunction peripheral (hereinafter, referred to as a “device”) is known. In the device management system, it is possible to manage the status, setting values, firmware, and address book including a plurality of destination information such as mail addresses for network devices to be managed. The device management system is capable of acquiring data from, and distributing data to, network devices to be managed via a network. The acquisition and distribution of data are often carried out through the execution of tasks, and it is generally possible to set the execution time of each task. Japanese Patent Laid-Open Publication No. 2011-141697 discloses a technique in which, in a batch processing task (hereinafter, referred to as a “batch processing task”) that collectively executes a plurality of tasks, the execution of a subsequent task is controlled based on the result of a preceding task.

However, although Japanese Patent Laid-Open Publication No. 2011-141697 does disclose that, when confirming the execution result of a task, it is possible to confirm the execution result of the task for each target device from the task execution history, it does not disclose how to determine what kind of error has occurred in each device. Additionally, from the viewpoint of an increase in the number of devices to be managed, cost reduction of the management server, and ease of maintenance, the number of devices manageable by a single management apparatus within the device management system has increased, and the number of target devices displayed on an execution target screen has also increased. Therefore, in order to improve convenience for the administrator, it is necessary to display, in a list, the type of error that has occurred in each device targeted by the task execution, so that the administrator can grasp the situation at a glance.

### SUMMARY

The present disclosure improves the convenience for a user who checks the status of task errors.

A management apparatus according to the present disclosure is a management apparatus that manages network devices via a network, and includes an execution unit configured to execute a task on a network device selected from among network devices to be managed, and a display control unit configured to control display of an execution result of the task, wherein the display control unit displays, for a task that has ended due to an error, a detailed screen that displays for each of the network devices, in a list, information indicating a network device that is the target of the task, an error type, and detailed error information.

Features of the present disclosure will become apparent from the following description of embodiments with reference to the attached drawings. The following description of embodiments are described by way of example.

### BRIEF DESCRIPTION OF THE DRAWINGS

FIG. 1 is a diagram illustrating a configuration of a device management system.

FIG. 2 is a diagram illustrating a hardware configuration of a device management server.

FIG. 3 is a diagram illustrating a software configuration of the device management server.

FIG. 4 is a diagram illustrating a software configuration of a device.

FIG. 5 is a diagram illustrating an example of a UI for device search.

FIG. 6 is a diagram illustrating an example of a UI for task creation.

FIG. 7 is a diagram illustrating an example of a UI for task creation.

FIG. 8 is a diagram illustrating an example of a UI for task execution history.

FIG. 9 is a diagram illustrating an example of a detailed screen of task execution results in a first embodiment.

FIG. 10 is a flowchart illustrating display processing of the detailed screen of task execution results in the first embodiment.

FIG. 11 is a flowchart illustrating display processing of detailed error information.

FIG. 12 is a diagram illustrating an example of a detailed screen of task execution results of a batch processing task in the first embodiment.

FIG. 13 is a diagram illustrating an example of a detailed screen of task execution results in a second embodiment.

FIG. 14 is a flowchart illustrating display processing of a detailed screen of task execution results in the second embodiment.

FIG. 15 is a flowchart illustrating display processing of a device according to a selection of error types.

FIG. 16 is a diagram illustrating an example of a detailed screen of task execution results of a batch processing task in the second embodiment.

### DESCRIPTION OF THE EMBODIMENTS

### First Embodiment

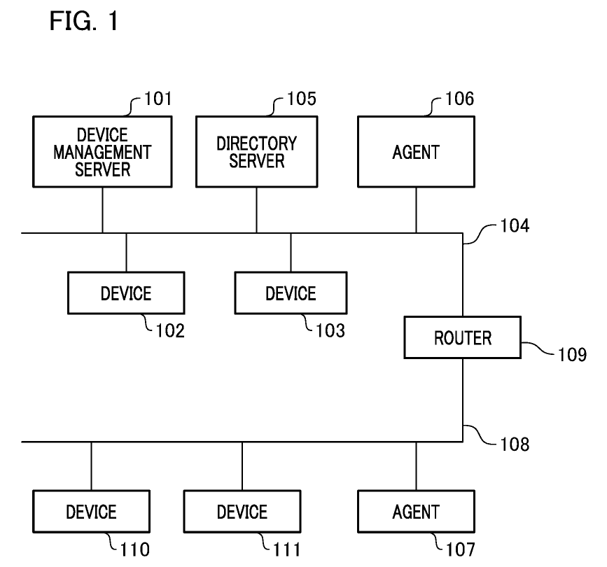

FIG. 1 is a diagram illustrating a configuration of a device management system. A network device management system (hereinafter, referred to as "device management system") provides a service (function) to a network device (hereinafter, also referred to as a "device") via a network. In a case in which the number of devices to be managed is large, the device management system may be configured by a management apparatus that performs overall management, and a plurality of agents that executes processing on the devices according to instructions from the management apparatus.

A device management server 101 manages network devices via a network. The device management server 101 is, for example, a management apparatus having a device management application. The device management application provides functions for managing target network devices. An agent 106 and an agent 107 are agent devices that have agent applications. In the example shown in FIG. 1, the device management system includes a single device management server 101 and a plurality of agent application devices, namely, the agent 106 and the agent 107. The device management system manages a device 102, a device 103, a device 110, and a device 111 as network devices.

Each agent is associated with a corresponding network device based on, for example, a device address. For example, the agent 106 is associated with the devices 102 and 103, and the agent 107 is associated with the devices 110 and 111. Note that although, in the present embodiment, the case of two agents and four devices is explained as an example, the configuration and operation are similar even in a case in which tens of thousands of devices are managed via a dozen or more agents.

Additionally, the device management system may include a directory server 105. The directory server 105 is an information processing apparatus that manages user information, such as user accounts. The device management server 101 and the directory server 105 are connected to each other through a network 104. The device management server 101 may be set such that a user of the directory server 105 can log in as a user of the device management server 101.

The device management server 101, the directory server 105, the agent 106, and the device 102 and the device 103 are connected to one another through the network 104. The network 104 is, for example, a WAN. The agent 107, the device 110, the device and 111 are connected to one another through a network 108. The network 108 is, for example, a LAN. The network 104 and the network 108 are connected through a router 109. The router 109 may also be configured, for example, to allow communication between the device management server 101 and the agent 107 on the network 108, and to block communication between the device management server 101, the device 110, and the device 111. Note that although in the present embodiment, a case in which the network 104 is a WAN and the network 108 is a LAN is explained as an example, the network 104 and the network 108 only need to be configured to allow transmission and reception of data, and the communication scheme is not limited. For example, each network may be configured using any of a LAN, a WAN, a cellular network such as LTE or 5G, a wireless network, a telephone line, a dedicated digital line , and the like, or a combination thereof.

In the present embodiment, communication between the device management server 101 and the devices 102 and 103 is assumed to be performed via the agent 106. Additionally, communication between the device management server 101 and the device 110 and the device 111 is assumed to be performed via the router 109 and the agent 107. Note that although, in the present embodiment, an example is explained in which the device management server 101 and the agent 106 operate on different hosts, the device management server 101 and the agent 106 may alternatively operate on the same host. In a case in which the device management server 101 and the agent 106 operate on the same host, the device 102 and the device 103 are capable of communicating directly with the device management server 101.

The device management server 101 provides various services (functions) to network devices to be managed. Note that, the device management server 101 in the present embodiment provides services to the network devices by using agents. The services provided by the device management server 101 include, for example, distribution (update) of firmware for the network devices. Additionally, the device management server 101 may also collect data from network devices and provide operating information for the network devices to an administrator. Note that the device management server 101 may be realized using one or more information processing apparatuses, a virtual machine (cloud service) that utilizes resources provided by a data center including information processing apparatuses, or a combination thereof. The directory server 105 may also be realized using one or more information processing apparatuses, a virtual machine (cloud service) that utilizes resources provided by a data center including information processing apparatuses, or a combination thereof. Additionally, the device management system can also be implemented as a web-based application and can also be used on a PC via a web browser.

The agent 106 and the agent 107 are agent devices that communicate with the network devices, based on instructions from the device management server 101. The agent 106 and the agent 107 are associated with the network devices according to addresses of the network devices and the like. The agent 106 is associated with the device 102 and the device 103. The agent 107 is associated with the device 110 and the device 111.

The device 102, the device 103, the device 110, and the device 111 are network devices that are managed by the device management server 101 and are capable of communicating with the device management server 101. The network device is, for example, an image processing apparatus having a printing function, such as a multifunction peripheral (MFP) in which a plurality of functions, such as a printing function, a reading function, and a fax function, are integrated. Note that the network device may also be an image forming apparatus such as a printer, a scanner, or a 3D printer, an information processing apparatus such as a PC, an image processing apparatus such as a camera, or a smart home appliance.

Hereinafter, processing by the network device management system will be explained using the device management server 101, the agent 106, and the device 102 as an example. First, a processing flow for providing a service to a network device by the network device management system will be explained. The device management server 101 instructs the agent 106 to perform an operation on the device 102. The agent 106 performs an operation such as transmitting a request to the device 102 according to an instruction from the device management server 101, and transmits a result thereof to the device management server 101. Thus, communication is performed between the device management server 101 and the agent 106, and between the agent 106 and the device 102. Note that, in a case in which the number of network devices to be managed is small, the agent may be omitted, and the device management server 101 and the network device may directly communicate with each other without the intervention of an agent.

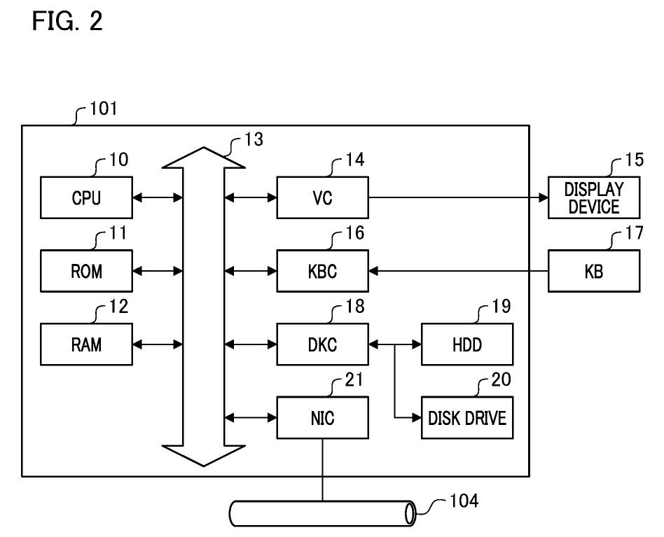

FIG. 2 is a diagram illustrating a hardware configuration of the device management server 101. The device management server 101 includes a CPU 10, a ROM 11, a RAM 12, a VC 14, a KBC 16, a DKC 18, and a NIC 21. The CPU 10, the ROM 11, the RAM 12, the VC 14, the KBC 16, the DKC 18, and the NIC 21 are connected via a system bus 13. Additionally, the device management server 101 includes an HDD 19 and a disk drive 20. The CPU 10 controls the entire device management server 101. The ROM 11 is a data readout-only memory and stores, for example, a basic control program of the device management server 101. The RAM 12 is a memory capable of reading out and writing data, and functions as a work area for the CPU 10. The disk controller (DKC) 18 controls access to a storage device such as the HDD 19. The hard disk drive (HDD) 19 is an example of a storage device and stores various programs, data, and the like. Note that although, in the present embodiment, an example is explained in which the information processing apparatus includes an HDD 205 as a storage device, the present invention is not limited thereto, and another storage device such as an SSD may be used. The disk drive 20 is capable of loading a storage medium that is an external medium, such as a CD-ROM, a DVD, a magnetic tape, and an IC memory card. The CPU 10 comprehensively controls the respective components that are connected to the system bus 13 by executing a program stored in the ROM 11 or the HDD 19 while using the RAM 12 as a work area.

The video controller (VC) 14 serves as an output interface and controls the display on a display device 15. The display device 15 is a display that displays output from the device management server 101 to a user and is, for example, a liquid crystal display (LCD). A keyboard controller (KBC) 16 serves as an input interface and controls input from a keyboard (KB) 17 to the device management server 101. The KB 17 is a keyboard that receives input from a user. Note that the keyboard is merely an example of an input device, and other input devices, such as a pointing device, may be connected to the KBC 16. Additionally, the display device 15 and the KB 17 may be realized as an integrated touch panel. By associating input coordinates with display coordinates on the touch panel, it is possible to construct a GUI such that makes it seem possible for the user to directly operate the screen displayed on the touch panel. The network interface card (NIC) 21 is a communication controller. The device management server 101 is connected to the network 104 via the NIC 21 and performs data communication with devices on the network 104.

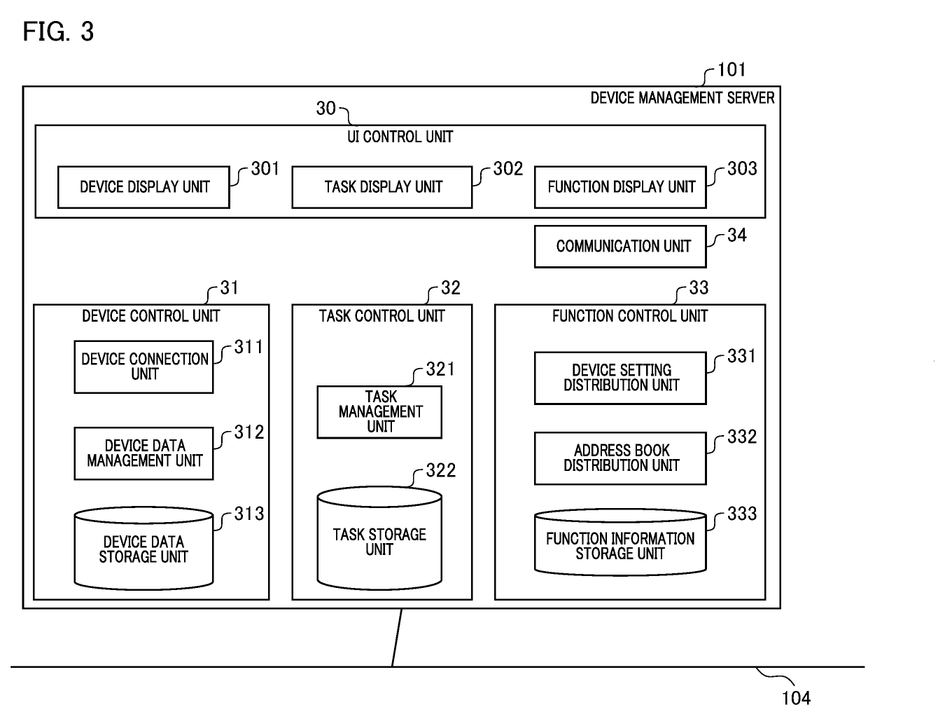

FIG. 3 is a diagram illustrating a software configuration of the device management server 101. The device management server 101 includes software modules such as a UI control unit 30, a device control unit 31, a task control unit 32, a function control unit 33, and a communication unit 34. The software module configuration is realized by the CPU 10 executing a program stored in a memory (the ROM 11 or the HDD 19), after reading the program onto the RAM 12.

The UI control unit 30 includes a device display unit 301, a task display unit 302, and a function display unit 303. The device display unit 301 controls display of a UI of the device control unit 31 and further receives a user operation on the UI. The task display unit 302 controls display of a UI of the task control unit 32 and further receives a user operation on the UI. That is, the task display unit 302 and the task control unit 32 control display of a screen for confirming an execution result (execution history) of a task and a screen for confirming details of an error that has occurred during execution of the task. The function display unit 303 controls display of a UI of the function control unit 33 and further receives a user operation on the UI. Note that although, in the present embodiment, an example is explained in which the UI is displayed on the display device 15 of the device management server 101, the present embodiment is not limited thereto. The UI control unit 30 may provide the UI to an external device on the network via a web browser, and may cause the UI to be displayed on a monitor of the external device.

The device control unit 31 manages information for devices to which the device management server 101 provides a management service. The device control unit 31 includes a device connection unit 311, a device data management unit 312, and a device data storage unit 313. The device connection unit 311 performs device searches, collects information from devices, and issues setting instructions to the devices. An example of a function of the device connection unit 311 is a device search function for the device 102 using SNMP, IP Broadcast, SLP/Multicast, and the like. In such a case, the device connection unit 311 performs a search for the device 102 at an arbitrary timing. The device connection unit 311 also has a function of acquiring/changing device information such as Management Information Base (MIB) security policy information via the network 104. Additionally, as a result of device search, the device connection unit 311 acquires device information such as device names, product names, and IP addresses, and stores the acquired information in the device data storage unit 313. The device data management unit 312 manages data stored in the device data storage unit 313. The device data storage unit 313 stores device information and the like. The device data storage unit 313 is a data recording medium, such as a database, that operates on the HDD 19.

The task control unit 32 manages tasks that are provided by device management services. In the present embodiment, services (functions) provided by the device management server 101 to devices are managed as tasks. In a task, for example, a process to be executed on a device, an execution date and time, and a target device from among the devices that are managed by the device management server 101 are set. In the present embodiment, an example is explained in which, as a task, the processes of distributing setting values to be applied to devices and distributing address books are executed.

The task control unit 32 includes a task management unit 321 and a task storage unit 322. The task management unit 321 cooperates with each function of the function control unit 33, generates and manages tasks that have been input via the task display unit 302, and stores the tasks in the task storage unit 322. Additionally, upon execution of a task, the task management unit 321 instructs the agent 106 to perform operations on the device 102 via the function control unit 33. The task management unit 321 also acquires the execution result of the task from the device and manages the acquired result. Additionally, the task management unit 321 performs display control, via the task display unit 302, to display the execution result of the task on the display device 15. Therefore, the task management unit 321 and the task display unit 302 function as display control units that control displays related to tasks. As part of displaying the execution result of a task, the task management unit 321 also performs control for displaying details of errors related to the task. The task storage unit 322 stores tasks generated by the task management unit 321. The task storage unit 322 is a data recording medium, such as a database, that operates on the HDD 19.

The function control unit 33 controls functions that are provided to the devices. In the present embodiment, the function control unit 33 executes tasks for the devices based on instructions from the task control unit 32. The function control unit 33 includes a device setting distribution unit 331, an address book distribution unit 332, and a function information storage unit 333. The device setting distribution unit 331 controls the distribution of settings to devices based on input from the function display unit 303 or on a schedule specified in the distribution task. The address book distribution unit 332 controls distribution of address books to network devices based on input from the function display unit 303 or on a schedule specified in the distribution task. Thus, the device setting distribution unit 331 and the address book distribution unit 332 execute tasks according to instructions from the task management unit 321, thereby providing functions to the devices. The task management unit 321 and each distribution unit of the function control unit 33 function as task execution units that execute tasks targeting devices selected from among the managed devices. The function information storage unit 333 records, for example, data distributed by the device setting distribution unit 331 and the address book distribution unit 332. The data stored in the function information storage unit 333 includes, for example, a task list, a device list, function information, and the like. The communication unit 34 controls communication with external devices on the network, such as the device 102.

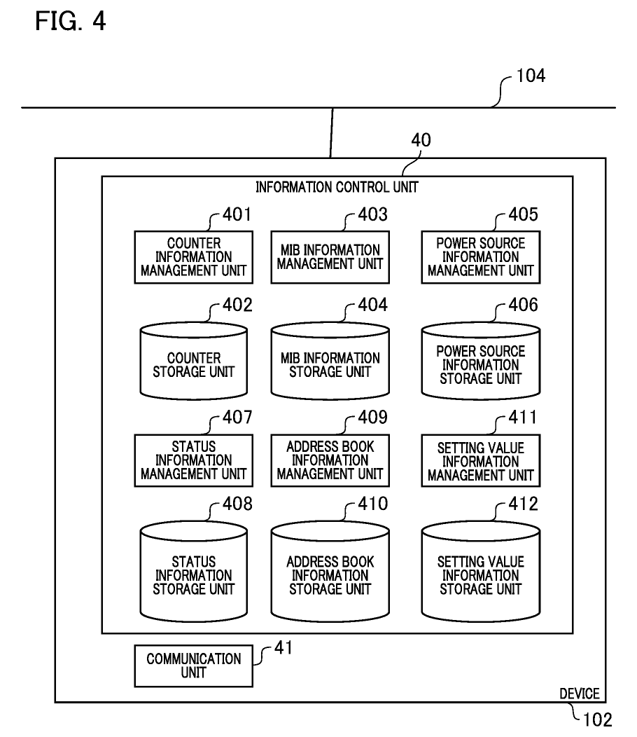

FIG. 4 is a diagram illustrating a software configuration of the device 102. The configuration of the software modules is realized by the CPU of the device 102 executing a program stored in a memory. The device 102 includes, as software modules, an information control unit 40 for managing a plurality of dynamically changing information groups, and a communication unit 41. The information control unit 40 includes a counter information management unit 401, an MIB information management unit 403, a power source information management unit 405, a status information management unit 407, an address book information management unit 409, and a setting value information management unit 411. Additionally, as storage region for data corresponding to the respective management units, the information control unit 40 includes a counter storage unit 402, an MIB information storage unit 404, a power source information storage unit 406, a status information storage unit 408, an address book information storage unit 410, and a setting value information storage unit 412.

The counter information management unit 401 manages information such as the number of printed pages and the like and stores the managed information in the counter storage unit 402. The MIB information management unit 403 manages MIB information, which is the device information described above, and stores it in the MIB information storage unit 404. The power source information management unit 405 manages power-off information and reboot information and stores the managed information in the power source information storage unit 406. The status information management unit 407 manages device status information, such as online, offline, and error states, and stores the managed information in the status information storage unit 408.

The address book information management unit 409 manages information such as the structure and data of an address book and stores the managed information in the address book information storage unit 410. Address book information distributed from the device management server 101 is also managed by the address book information management unit 409 and stored in the address book information storage unit 410. The setting value information management unit 411 manages various setting values related to the device, such as print settings and network-related settings, and stores the managed information in the setting value information storage unit 412. The data managed by each management unit is transmitted to the device management server 101 via SNMP or other protocols in response to a request from the device management server 101. The communication unit 41 controls communication with external devices on the network, such as the device management server 101. The connection method between the communication unit 41 and the network 104 is not limited, and may be, for example, a wireless LAN, a network card (LAN card), a wired cable, and the like.

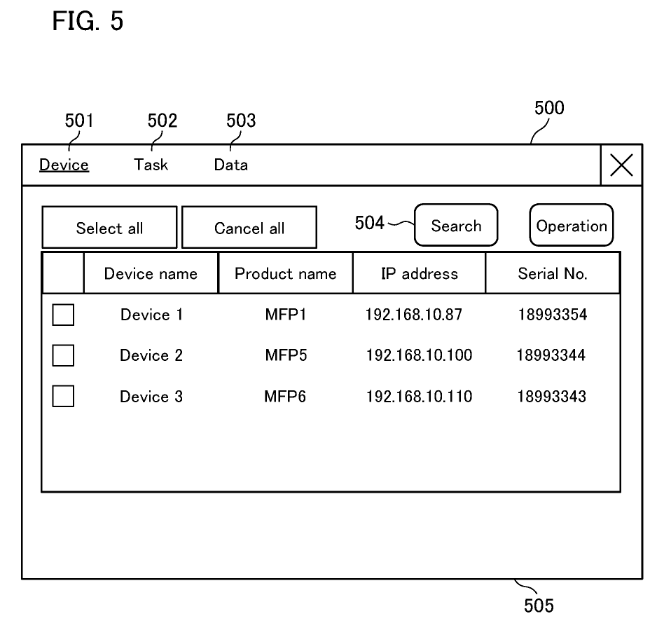

The device management server 101, as part of device management, creates a task targeting a device, executes the task, manages the execution result of the task as history, and displays the task history so that a user can refer to it. A flow for the device search, task creation, and task history referencing in the device management server 101 will be explained with reference to FIG. 5 to FIG. 8. For example, when the task button is selected on the home screen provided by the device management system on the device management server 101, a task management screen including a device tab 501, a task tab 502, and a data tab 503 is displayed. FIG. 5 to FIG. 8 show examples of the task management screen.

First, a device search will be explained with reference to FIG. 5. FIG. 5 is a diagram illustrating an example of a UI for the device search. When the device management server 101 manages devices, it first performs search of network devices that are to be managed. The device management server 101 searches for network devices to be managed on the network. Although the search algorithm may be, for example, SNMP, the method is not limited thereto. Device search may be performed each time there is an instruction from a user, or may alternatively be performed periodically based on a schedule that has been set.

When it is detected that the user has selected the device tab 501 on the task management screen, the UI control unit 30 displays a search screen 500. The search screen 500 is a UI provided by the UI control unit 30 of the device management server 101. On the search screen 500, a search button 504 is displayed. When the search button 504 is pressed down, a search setting screen (not illustrated) is displayed. The user performs search settings on the search setting screen and instructs the device search. On the search setting screen, for example, the network range for searching for devices, a search method, and IP addresses to be excluded from the search range can be set. The device management server 101 performs the device search according to the search settings that have been specified by the user.

After the device search, a device list 505 indicating the search results is displayed on the search screen 500. Device information for the searched devices is displayed in the device list 505. The device information includes, for example, a device name, a product name, an IP address, a serial number, and the like. The device information displayed in the device list 505 includes, for example, information for devices obtained in the current search and information for devices obtained in previous searches and is stored in the device data storage unit 313. Additionally, the device data management unit 312 manages, as the device list, the devices displayed in the device list 505, that is, all managed target devices that have been searched for up to now. From the device list 505, the user can select, from among the network devices that are managed as targets a network device to be targeted by a task,.

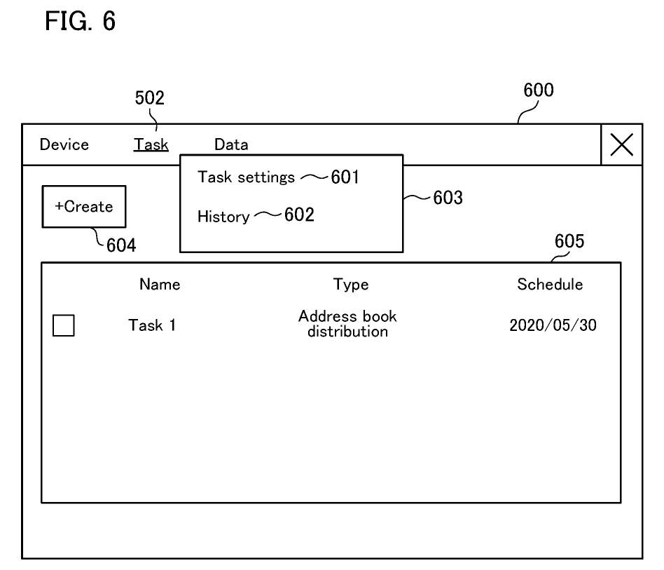

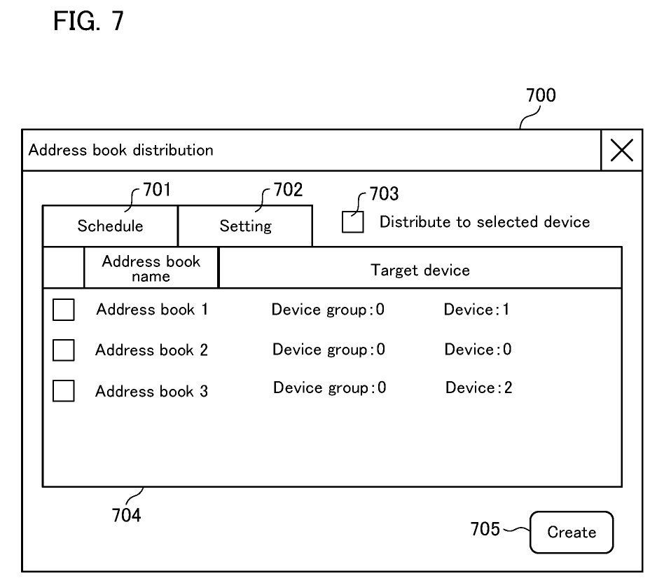

FIG. 6 and FIG. 7 are diagrams each illustrating an example of a UI for task creation. In the present embodiment, an example will be explained in which a task for distributing an address book is created as an example of the task creation. When the task tab 502 is selected, the UI control unit 30 displays a popup 603 to allow selection between the setting of a task and a task history display. In the popup 603, a task setting button 601, which is selected in the case of performing task setting, and a history button 602, which is selected in the case of displaying task history, are displayed. When it is detected that the task setting button 601 has been selected, the UI control unit 30 displays a task screen 600 including a task list 605, which is a list of tasks currently set, and a +Create button 604. Note that the +Create button 604, which has been displayed in a non-selectable state, may be displayed in a selectable state in response to the selection of the task setting button 601. When it is detected that the +Create button 604 has been selected, the UI control unit 30 displays a list of tasks that can be created. The list of creatable tasks includes a batch processing task, and it is possible to create a task that collectively performs a plurality of processes (tasks). FIG. 7 illustrates an example in which “Distribution of an address book” has been selected from the list of creatable tasks.

An address book distribution setting screen 700 is a screen for creating a task for distributing an address book to a network device. On the address book distribution setting screen 700, for example, a schedule tab 701, a setting tab 702, a checkbox 703, and a create button 705 are displayed. The checkbox 703 is a checkbox for selecting whether or not to distribute the address book to the selected device. In a case in which the checkbox 703 is checked, a task is created for distributing an address book that was previously associated with a device that has been previously selected in, for example, the device list 505. In contrast, in a case in which the checkbox 703 is not checked, the content of the task is set from the setting tab 702. When it is detected that the setting tab 702 has been selected, the UI control unit 30 displays an address book list 704. In the address book list 704, the address books that are stored in the function information storage unit 333 are displayed in a list. In the address book list 704, for example, checkboxes for selecting address books, names of address books, and a number of devices or a number of device groups associated with the respective address books are displayed. The user selects an address book to be distributed and checks a checkbox corresponding to the address book. When it is detected that the schedule tab 701 has been selected, the UI control unit 30 displays a screen by which a schedule (distribution date and time) for distributing the address book is set. The user sets an address book to be distributed and a distribution date and time and selects the create button 705. When it is detected that the create button 705 has been selected, the task management unit 321 creates a task for distributing an address book based on the set content. The created task is stored in the task storage unit 322.

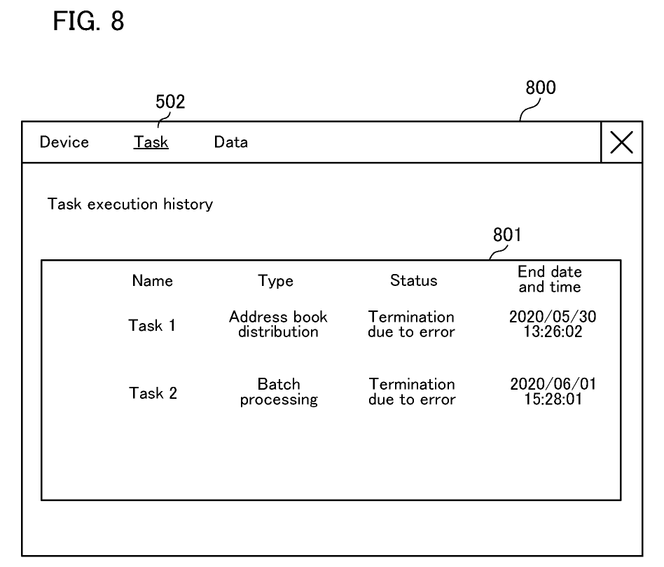

The created task is displayed in the task list 605 of the task screen 600 until execution of the task. On the other hand, after the created task has been executed, the task is displayed on a screen indicating an execution history of tasks. FIG. 8 illustrates an example of the task execution history screen. FIG. 8 is a diagram illustrating an example of a UI for task execution history. When it is detected that the history button 602 has been selected in the popup 603 that is displayed after the task tab 502 has been selected, the UI control unit 30 displays a task execution history screen 800. In the task execution history screen 800, a list of executed tasks is displayed as an execution history list 801. In the execution history list 801, for example, tasks that have been executed within a predetermined period such as the most recent three months may be displayed, or all tasks that have been executed may be displayed. In the execution history list 801, for example, a task name, a task type, a status of task execution, and an end date and time of the task are displayed.

In a case in which the status of a task is “Termination due to an error,” which indicates that the task was ended (interrupted) due to an error, the user is able to request a display of the error details by clicking on the status “Termination due to an error”. Note that the display indicating that the task has been ended (interrupted) due to an error is not limited to the expression “Termination due to an error,” and may instead be, for example, display of an icon. Task 1 in the execution history list 801 indicates that the address book distribution task displayed in FIG. 6 has been ended (interrupted) due to an error. When it is detected that the status “Termination due to an error” has been clicked, the UI control unit 30 displays a detailed screen of the task execution results. In the present embodiment, details of the errors in the execution of the task for each target device can be displayed in a list on a screen for displaying the details of the task execution results (hereinafter referred to as a “task execution result detail screen”).

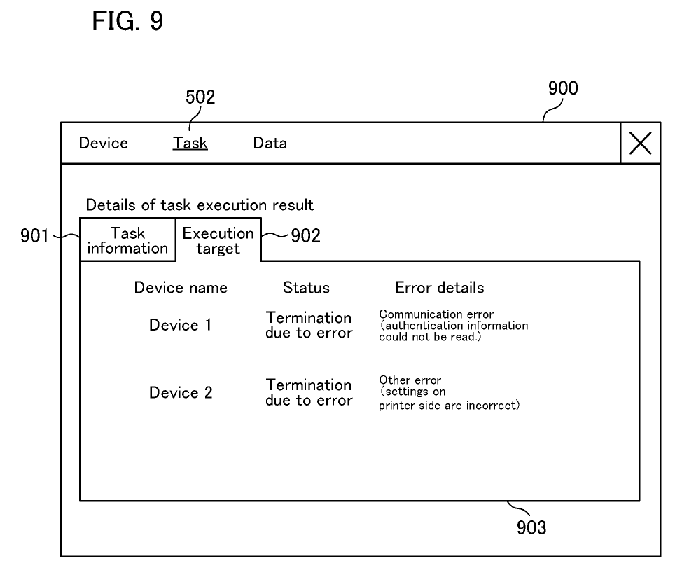

FIG. 9 is a diagram illustrating an example of a detailed screen of task execution results in a first embodiment. A task execution result detail screen 900 is displayed by the UI control unit 30 in response to selection of a status indicating that a task has been ended due to an error, in the execution history list 801 of the task execution history screen 800. FIG. 9 illustrates an example in which termination due to an error of the address book distribution task, which corresponds to Task 1, in the execution history list 801 of FIG. 8, is selected. In the task execution result detail screen 900, a task information tab 901 and an execution target tab 902 are displayed in a selectable manner, and information corresponding to the tab specified by the user is displayed. In a case in which the task information tab 901 has been selected, detailed information that has been set in the task, such as contents of the corresponding task and target devices, is displayed. FIG. 9 illustrates a state in which the execution target tab 902 has been selected. When it is detected that the execution target tab 902 has been selected, the UI control unit 30 displays, in a detail list 903, details of execution results of the task for each device that is a target of execution.

In the detail list 903, information indicating a network device targeted by the task, and, as error details for each network device, an error type and detailed error information are displayed in a list for the tasks that were ended due to an error. Additionally, in the detail list 903, a status of the task, a date and time of execution of the task, and the like may also be displayed. In the detail list 903 that is illustrated in FIG. 9, for example, a device name that serves as information indicating a device targeted by the task, the status of the task, and the error details (an error type and detailed error information) are displayed. Note that the information indicating a network device targeted by the task may be any information capable of identifying the device, and may include, for example, a serial number, an IP address, an installation location, or other device information. The error type and detailed error information are displayed as the error details. The error type is a type of error that is classified into a plurality of types based on the content of the error. The detailed error information is information indicating at least one of, for example, a cause of the error, a component in which the error has occurred, and a recommended action for resolving the error. The recommended action for resolving the error is estimated, for example, by the device management server 101 or a server that cooperates with the device management server 101, based on the cause of the error and the like. Additionally, as the detailed error information, information indicating, for example, whether or not remote handling is possible for the recommended action for resolving the error may also be displayed. In the example that is shown in FIG. 9, in Device 1, the cause of the task termination due to an error is a communication error, and detailed information indicating that the authentication information could not be read is displayed. In Device 2, the cause of the task termination due to an error is an unclassified “Other error”, and detailed information indicating that a setting on the printer side is not correct is displayed. As described above, in the detail list 903, detailed contents of errors can be displayed in a list for each device, and the user can grasp, at a glance, what kind of error has occurred in each device by checking the detail list 903.

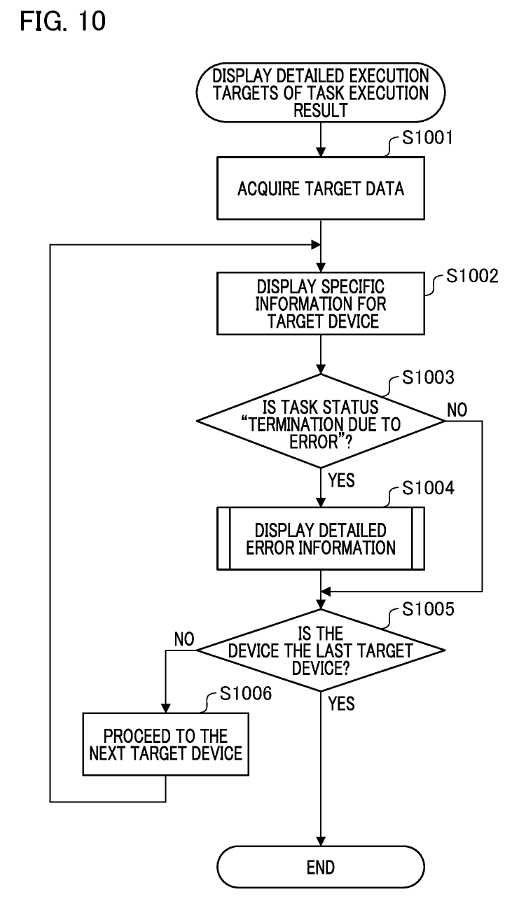

FIG. 10 is a flowchart illustrating display processing for the detailed screen of task execution results in the first embodiment. Each process shown in FIG. 10 is realized by the CPU 10 of the device management server 101 executing a program stored in a memory (the ROM 11 or the HDD 19). The present process is started in response to detection, by the device management server 101, that a status indicating that a task has been ended due to an error has been selected by the user in the execution history list 801 of the task execution history screen 800.

In step S1001, task data is acquired by the task management unit 321 from the task storage unit 322. The task data acquired here is information regarding a task for which a status that indicates that the task has been ended due to an error is selected by the user. The task data includes execution contents set in the task, information regarding a device targeted by the execution of the task, and the execution result for the task including detailed error information. For example, in a case in which a status indicating that Task 1 (an address book distribution task) has been ended due to an error is selected in the execution history list 801 that is shown in FIG. 8, the task management unit 321 acquires information regarding the target device and task information for the address book distribution task. In this case, the target devices are Device 1 and Device 2, and the tasks for both of these have been ended due to an error, in which the error for Device 1 is a communication error (the authentication information could not be read), and the error for Device 2 is another type of error (a setting on the printer side is not correct).

Each of the processes from step S1002 to step S1006 is repeatedly executed for each target device of the task until processing for all target devices of the task has been completed. In step S1002, the task display unit 302 displays, for each device that is a target of the task execution, identification information for the target device from the task data that was acquired in step S1001. The identification information is information regarding a device that is a target of the task. Additionally, the identification information may include, for example, an IP address of the device, an installation location of the device, a date and time of the task execution, and the like. In the detail list 903, the identification information is the device name. The task display unit 302 may also display a status of the task together with the identification information. For example, in a case in which the target device of the processing is Device 1, Device 1 is displayed as the device name information, and “Termination due to an error” is displayed as the status information.

In step S1003, the task management unit 321 determines whether or not the status of the task is “Termination due to an error”. In a case in which the status of the task is “Termination due to an error”, the process of step S1004 is performed. On the other hand, in a case in which the status of the task is not “Termination due to an error”, the process of step S1005 is performed. In step S1004, the task display unit 302 displays error details. In the display of the error details, a type of the error and detailed information for the error are displayed. Since error details are displayed together with identification information for the device that is the target, the error details are displayed, on the list screen, for each device that is a target of task execution. Details of the processing for displaying the detailed error information in step S1004 are illustrated in FIG. 9. In a case in which the task being displayed is not a batch processing task, the error details are displayed in step S1013. A case in which the task is a batch processing task will be described below.

In step S1005, the task management unit 321 determines whether or not the device is the last target device of the task. In a case in which there remains a target device of the task that has not yet been displayed in the detail list 903, and it is determined that the device is not the last target device, the process in step S1006 is performed. On the other hand, in a case in which it is determined that the device is the last target device of the task, that is, it has been determined that all of the target devices of the task are displayed in the detail list 903, the present processing ends. In step S1006, the task management unit 321 updates the processing target to the next target device, and the process returns to step S1002.

By the processes from steps S1002 to S1004 with Device 1 as a target device, the error details for Device 1, “Communication error (authentication information is not read),” are displayed in the detail list 903 shown in FIG. 9. By steps S1005 and S1006, the process proceeds to processing in which Device 2 is the target device. By the processes from steps S1002 to S1004 with Device 2 as the target device, the error details for Device 2, “Other error (printer-side setting is not correct),” is displayed in the detail list 903 shown in FIG. 9. Through this series of operations, it becomes possible to display the error details of Device 1 and Device 2 on the task execution result detail screen (FIG. 9) that can be checked from the task execution history. According to the processing described above, in a case in which a task has ended due to an error, error details for each device targeted by the task can be displayed in a list as the detail list 903 on the task execution result detail screen 900 shown in FIG. 9.

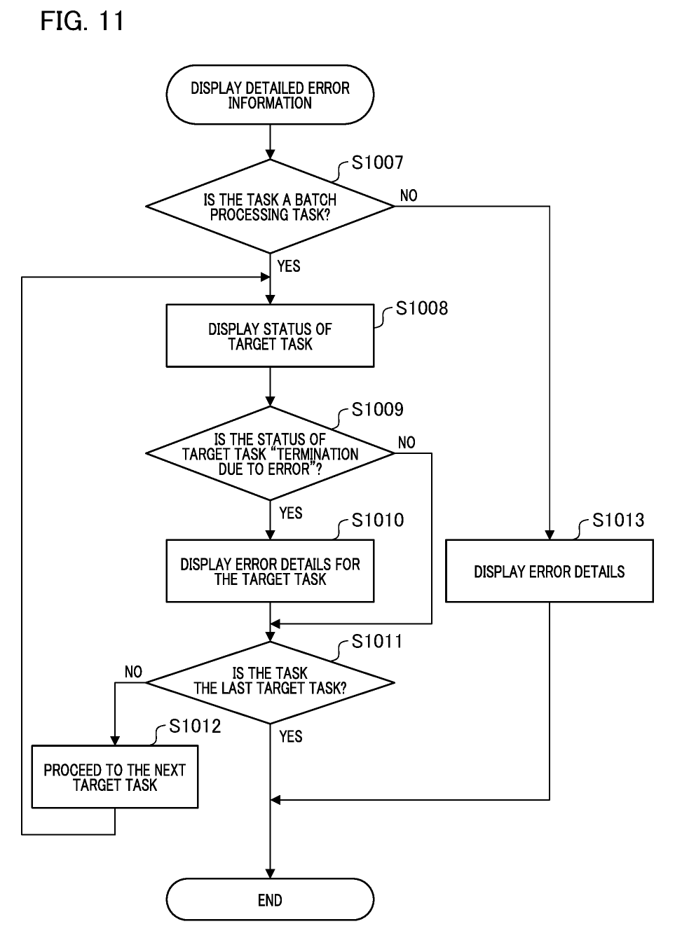

Next, the display of the detailed error information in a case in which a task that has ended due to an error is a batch processing task will be explained. FIG. 11 is a flowchart illustrating display processing for the detailed error information. Each process shown in FIG. 11 is realized by the CPU 10 of the device management server 101 executing a program stored in a memory (ROM 11 or HDD 19). This process is a process executed in step S1004 of FIG. 10. A batch processing task is a task that performs processing of a plurality of tasks collectively. In the display of detailed error information for a batch processing task, error details are displayed in a list for each task included in the batch processing task.

In step S1007, the task management unit 321 determines whether or not the selected task is a batch processing task. In a case in which it is determined that the selected task is a batch processing task, the process of step S1008 is executed. On the other hand, in a case in which it is determined that the selected task is not a batch processing task, the process proceeds to step S1013. As for a case in which the selected task is not a batch processing task, error details for the termination due to an error are displayed, as was explained in FIG. 10.

In a case in which the selected task is a batch processing task, the processes of steps S1008 to S1012 are repeatedly executed, thereby enabling display of each task that is included in the batch processing task, the status of each task, and the details of the errors. In the processes of steps S1008 to S1010, one of the plurality of tasks included in the batch processing task is set as a target, the task and a status thereof are displayed, whether or not the status indicates termination due to an error is determined, and, in a case in which the status indicates termination due to an error, a process of displaying error details is performed. The process is repeatedly executed for all of the tasks that are included in the batch processing task. In step S1008, the task display unit 302 displays a target task and a status thereof. The target task in this case is one task from among a plurality of tasks that are included in the batch processing task. Accordingly, the task display unit 302 displays a task name and a status of one task, which is the target of the processing from among a plurality of tasks included in the batch processing task for which the display of error details has been requested by the user. In a case in which an execution order is set for the tasks in the batch processing task, the target task may be determined according to the execution order.

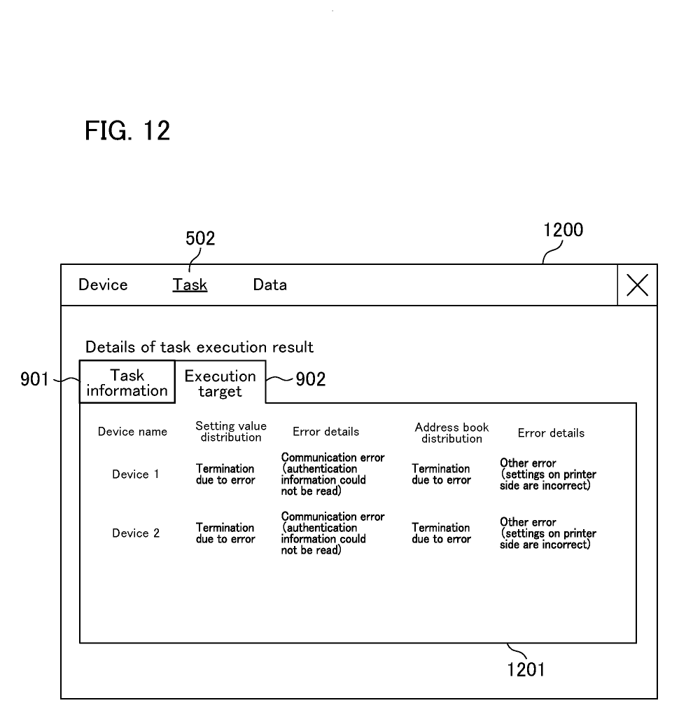

In step S1009, the task management unit 321 determines whether or not the status of the target task indicates termination due to an error. In a case in which the status of the task indicates termination due to an error, the process of step S1010 is performed. On the other hand, in a case in which the status of the task does not indicate termination due to an error, the process of step S1011 is performed. In step S1010, the task display unit 302 displays the error details. The task display unit 302 displays, as the error details, an error type and detailed error information. Details of the detailed error information display processing in step S1004 are illustrated in FIG. 12.

Hereinafter, a display of a detailed task execution result screen for a case in which the task is a batch processing task is explained. FIG. 12 is a diagram illustrating an example of a detailed task execution results screen for a batch processing task in the first embodiment. A task execution result detail screen 1200 is displayed by the UI control unit 30 in response to the selection of a status indicating that the task has been terminated due to an error in the execution history list 801 of the task execution history screen 800.

On the task execution result detail screen 1200, a task information tab 901 and an execution target tab 902 are displayed so as to be selectable, and information corresponding to a tab specified by the user is displayed. FIG. 11 illustrates a state in which the execution target tab 902 has been selected. When it is detected that the execution target tab 902 has been selected, the UI control unit 30 displays, in a detail list 1201, details of the task execution results for each device that is an execution target.

In the detail list 1201, for example, a device name, information for each task included in the batch processing task, a status of each task, and detailed error information are displayed. Note that the device name may be any identifier that is capable of identifying the device, and may be, for example, other device information such as a serial number. Additionally, information such as an IP address of the device, an installation location, or a date and time of the execution of the task may also be displayed. In the detailed error information, specific information regarding the error is displayed. In the example shown in FIG. 11, the batch processing task that was executed for Device 1 includes the two tasks of a distribution value setting task and an address book distribution task, and it is displayed that each of the tasks has ended due to an error, and the error details for each task are also displayed. The cause of the error that terminated the distribution value setting task is a communication error, and as the details, it is displayed that the authentication information could not be read. The cause of error that the terminated the address book distribution task is an unclassified other error, and as the details, it is displayed that a setting on the printer side is not correct. In the example shown in FIG. 11, it is also evident that the same applies to Device 2 as to Device 1. In a case in which the execution order of the tasks in the batch processing task is set, the information of the task to be executed first may be displayed adjacent to the device information, and the information of the tasks may be displayed in the order of execution (for example, from left to right). Thus, in a case in which the task is a batch processing task, the detail list 1201 displays, for each individual task included in the batch processing task, its status and, in the case of termination due to an error, detailed error contents in a list format. In the detail list 1201, the detailed contents of the errors for each task included in the batch processing task can be displayed in a list for each device, and the user can grasp, at a glance, what kind of error has occurred in each device by checking the detail list 1201.

In step S1011, the task management unit 321 determines whether or not the task is the last target task. That is, the task management unit 321 determines whether or not the processes from steps S1008 to S1010 have been executed for all of the tasks that are included in the batch processing task. In a case in which the task is the last target task, the present process ends. In contrast, in a case in which the task is not the last target task, the process of step S1012 is performed. In step S1012, the task management unit 321 updates the task to the next target task and the process returns to step S1008. The next target task is a task that is included in the batch processing task for which the processes from steps S1008 to S1010 has not yet been executed.

An example in which error details are displayed in the case of a batch processing task will be explained with reference to FIG. 8 and FIG. 12. For example, it is assumed that a batch processing task for performing both the distribution of setting values and the distribution of an address book is created, the task is executed at a scheduled time, and ends in failure, and this task is displayed as Task 2 in the execution history list 801 shown in FIG. 8. When the user clicks the status “termination due to an error” for Task 2, which is a batch processing task that is shown in the execution history list 801, target device information and task information for the batch processing task are acquired in step S1001. In this case, it is assumed that the target devices are Device 1 and Device 2, both of which have ended in error, where the setting value distribution task has ended in a communication error (authentication information is not read), and the address book distribution task has ended in another error (a setting error on the printer side).

In step S1002, “termination due to an error” is displayed as the status information for the batch processing task for Device 1, which has been acquired in step S1001. In step S1003, it is determined that the status is “termination due to an error”, and in step S1004, processing through steps S1007 to S1013 for displaying the detailed error information is executed. In step S1007, it is determined that the task is a batch processing task. In step S1008, first, “termination due to an error” is displayed as the status of the setting value distribution task. In step S1009, it is determined that the status of the setting value distribution task is “termination due to an error”, and in step S1010, “communication error (the authentication information could not be read)” is displayed. Through steps S1011 and S1012, the processing proceeds to display the next task (the address book distribution task). By the same steps S1008 to S1010, “termination due to an error” is displayed as the status for the address book distribution task, and “other error (printer-side setting is incorrect)” is displayed as the error details. Thereafter, in step S1011, it is determined that the task is the last one, and the process in step S1004 ends. By the processes of steps S1005 and S1006, the target device shifts to Device 2. For Device 2, processing similar to that for Device 1 is performed. Through this series of operations, it becomes possible to display, in the detailed task execution result screen (FIG. 12) of the batch processing task, which is confirmable from the task execution history, the detailed errors for each task for Device 1 and for Device 2.

According to this processing, in a case in which the task is a batch processing task comprised of a plurality of tasks, the detail list displays, for each device, each task that is included in the batch processing task and the error details for each task (an error type and detailed information for the error), in a list format. Therefore, the user can confirm, at a glance, the error details for each task that is included in the batch processing task for each target device of the task.

As was explained above, according to the present embodiment, in a case in which the task has terminated due to an error, it becomes possible to display, error details for each device that was targeted by the task in a list format on a task execution result detail screen that can be transitioned to from the task execution history. Additionally, in a case in which the task is a batch processing task, it becomes possible to display, in a list, the error details for each task that is included in the batch processing task for each device that was targeted by the task. By collectively displaying the error details in a list, the list-ability of the details, including the causes of the errors for each device, can be improved, thereby making it easier for the user to grasp at a glance what errors have occurred in each device. As a result, even in a case in which there are many devices, it is not necessary for the user to check the error details for each device individually, and the ease of understanding of the error statuses by the user can thereby be improved, and user convenience can be improved.

### Second Embodiment

In the first embodiment, an example has been explained in which detailed information for all of the errors is displayed for all target devices with respect to a task that was terminated due to an error. In the present embodiment, an example will be explained in which display is performed according to the type of error. More specifically, an example will be explained in which a type of error is selected, and only devices in which the selected type of error has occurred are displayed. Hereinafter, only differences from the first embodiment will be explained, and explanation of configurations and processes that are the same as those in the first embodiment will be omitted by assigning the same reference numerals thereto.

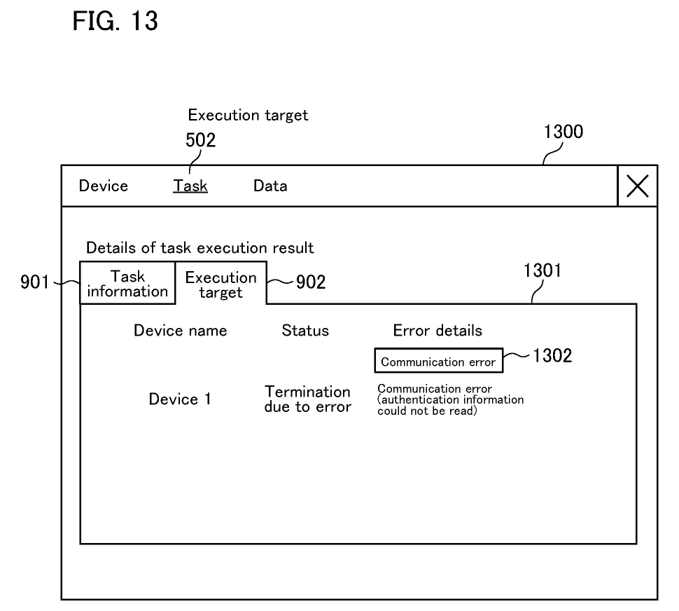

First, a case in which the target task is composed of a single task will be explained with reference to FIG. 13 to FIG. 15. FIG. 13 is a diagram illustrating an example of a detailed screen of task execution results in a second embodiment. A task execution result detail screen 900 is displayed by the UI control unit 30 in response to the selection of a status indicating that a task has been ended due to an error, in the execution history list 801 of the task execution history screen 800. FIG. 13 illustrates an example in a case in which the status “termination due to an error” for the address book distribution task, which is Task 1, is selected in the execution history list 801 shown in FIG. 8. A task information tab 901 and an execution target tab 902 are displayed on a task execution result detail screen 1300 so as to be selectable, and information corresponding to the tab specified by the user is displayed. FIG. 13 shows a state in which the execution target tab 902 has been selected. When it is detected that the execution target tab 902 has been selected, the UI control unit 30 displays, in a detail list 1301, detailed execution results of the task for each device that is an execution target.

In the detail list 1301, for example, a device name, a status of the task, details of the error, and an error type selection area 1302 are displayed. The error details include an error type and detailed information of the error. The error type selection area 1302 is, for example, a pull-down menu in which types of errors are displayed in a list. In the pull-down menu, a plurality of error types such as “communication error” and “other error”, and an “all” option for displaying all error types, are displayed so as to be selectable. Note that the selection of the error type is not limited to selection by a pull-down menu. In the example that is shown in FIG. 13, “communication error” is selected as the error type in the error type selection area 1302. Accordingly, in the detail list 1301, only devices for which the error type is “communication error” are displayed. The task that is the display target in FIG. 13 is the same task as the address book distribution task that is the display target in FIG. 9. In FIG. 9, both Device 1, which has an error type of communication error, and Device 2, which has an error type of other error, are displayed, whereas in FIG. 13, only Device 1, which has an error type of communication error, is displayed. As was described above, in the present embodiment, the detail screen 1300 receives a selection of an error type from the user, and network devices having the same error type as the selected error type are displayed in a list in the detail list 1301. By performing display according to the selected error type, it becomes possible to display only the devices for which the same type of error has occurred in the list.

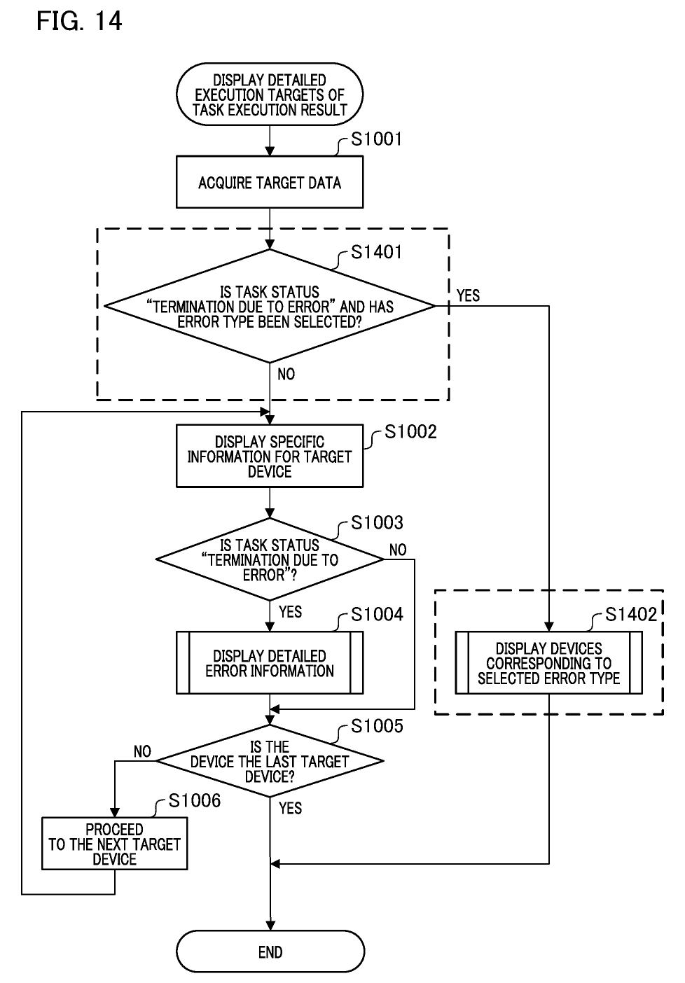

A process for performing display according to the type of error will be explained with reference to FIG. 14. FIG. 14 is a flowchart illustrating display processing for a detailed screen of task execution results in the second embodiment. Each process that is illustrated in FIG. 14 is realized by the CPU 10 of the device management server 101 executing a program stored in a memory (the ROM 11 or the HDD 19). The present process is started in response to detection, by the device management server 101, that a status indicating that a task has been ended due to an error has been selected by the user in the execution history list 801 of the task execution history screen 800. Additionally, it is assumed that “communication error” has been selected in the error type selection area 1302.

When data for the target task is acquired in step S1001, the process in step S1401 is performed. In step S1401, the task management unit 321 determines whether or not the status of the task is a termination due to an error and whether or not an error type has been selected. In a case in which the status of the task is a termination due to an error and an error type has been selected, the process in step S1402 is performed. On the other hand, in a case in which the status of the task is not a termination due to an error or an error type has not been selected, the process in step S1002 is performed. The processing in a case in which the status of the task is not a termination due to an error or selection of an error type has not been selected is the same as that in the first embodiment, and therefore, a description thereof will be omitted.

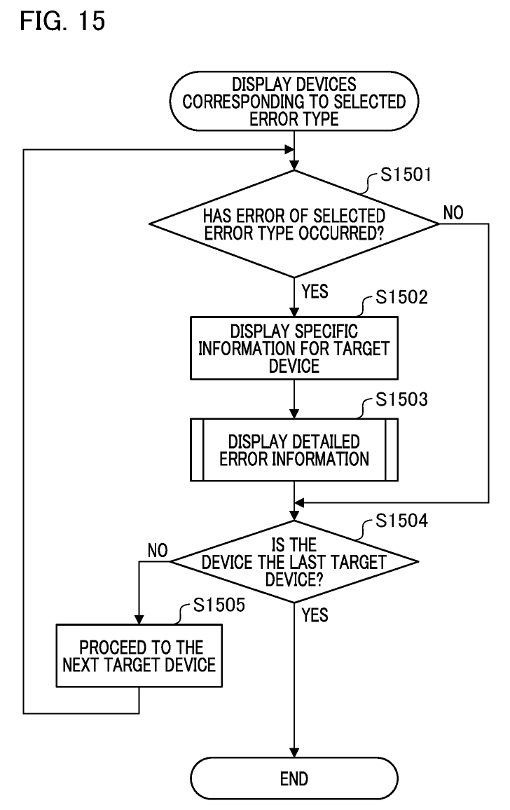

In step S1402, the task display unit 302 displays devices according to the selected error type. A device display process according to the selected error type will be explained with reference to FIG. 15. FIG. 15 is a flowchart illustrating display processing of a device according to a selection of error types. Each process shown in FIG. 15 is realized by the CPU 10 of the device management server 101 executing a program stored in a memory (the ROM 11 or the HDD 19). Note that the processing of step S1402, that is, each process shown in FIG. 15, is repeatedly executed for each target device of the task, and the processing of step S1402 is completed when the processing for all of the devices that are the targets of the task has been completed. Hereinafter, it is assumed that the data acquired in step S1001 indicates that the target devices of an address book distribution task are Device 1 and Device 2, that the tasks for both devices have been terminated due to an error, and that the error type for Device 1 is a communication error and the error type for Device 2 is an error other than a communication error.

In step S1501, the task management unit 321 determines whether or not an error of the error type selected by the user has occurred. In a case in which it is determined that an error of the error type selected by the user has occurred, the process in step S1502 is performed. In contrast, in a case in which it is determined that an error of the error type selected by the user has not occurred, the process in step S1004 is performed. For example, in a case in which a communication error is selected in the error type selection area 1302 in the error detail display of the address book distribution task shown in FIG. 13 and the target device of the processing is Device 1, it is determined that an error of the selected error type has occurred. In contrast, in a case in which the target device of the processing is Device 2, it is determined that an error of the selected error type has not occurred.

In steps S1502 and S1503, processing is performed to display the device information and error details for a device in which an error of the error type to be displayed has occurred. In step S1502, the task display unit 302 displays identification information for the target device in the data that was acquired in step S1001. The identification information includes the device information, the status, and the like. In step S1503, the task display unit 302 displays the detailed error information. The processing of step S1503 is the same as that of steps S1004 (S1007 and S1013) in a case in which the task is a single task (not a batch processing task) in the first embodiment. For example, for Device 1, the device information and the detailed error information are displayed in steps S1502 and S1503 (FIG. 13).

In step S1504, the task management unit 321 determines whether or not the device is the last target device of the task. In a case in which it is determined that the device is not the last target device of the task, the process in S1505 is performed. On the other hand, in a case in which it is determined that the device is the last target device of the task, the processing ends. In step S1505, the task management unit 321 updates the processing target to the next target device, and the process returns to step S1501.

By this series of processes, it becomes possible to select an error type on an execution target screen for the task execution result, which can be confirmed from the task execution history, and to display only devices in which a specific error corresponding to the selected error type has occurred. As a result, it becomes possible to display only the devices in which a specific error has occurred in a list, thereby improving the ease with which the user can grasp the error status, and also enhancing the user convenience.

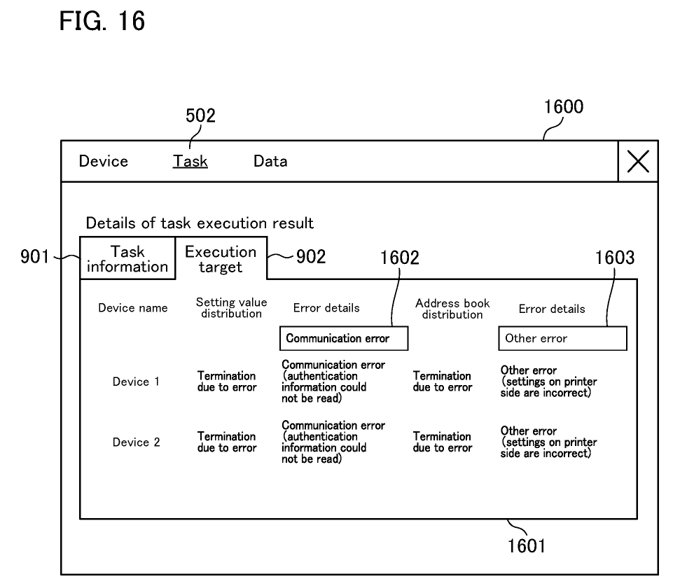

Next, the display according to types of error details in a batch processing task will be explained. FIG. 16 is a diagram illustrating an example of a detailed screen of task execution results of a batch processing task in the second embodiment. A task execution results detail screen 1600 is displayed by the UI control unit 30 in response to selection of a status indicating that the task was terminated due to an error, in the execution history list 801 of the task execution history screen 800. FIG. 16 illustrates an example in a case in which error termination of a batch processing task, which is Task 2, is selected in the execution history list 801 in FIG. 8. On the task execution result details screen 1600, a task information tab 901 and an execution target tab 902 are displayed so as to be selectable, and information corresponding to the tab specified by the user is displayed. FIG. 16 illustrates a state in which the execution target tab 902 has been selected. When it is detected that the execution target tab 902 has been selected, the UI control unit 30 displays, in a detail list 1601, task execution results for each device that is an execution target.

In the detail list 1601, for example, a device name, a task status for each task, error details, and error type selection areas (selection area 1602 and selection area 1603) are displayed. An error type and detail information of the error are displayed as the error details. The error type selection area 1602 and the error type selection area 1603 are, for example, pull-down menus in which error types are listed. The selection area 1602 is an area for selecting the error type of the setting distribution task. The selection area 1603 is an area for selecting the error type of the address book distribution task. Thus, the error type can be selected for each task included in the batch processing task. In the example illustrated in FIG. 13, a communication error is selected as the error type in the error type selection area 1302, and another error is selected as the error type in the error type selection area 1303. By performing display according to the selected error type, it becomes possible to display in a list only the devices in which the same type of error has occurred.

Processing for displaying the task execution result details screen 1600 for the batch processing task illustrated in FIG. 16 will be explained with reference to FIG. 14 and FIG. 15. Here, it is assumed that a batch processing task including two tasks, namely, a setting distribution task and an address book distribution task, has been selected as the batch processing task to be displayed. The target devices and error details of this batch processing task are as shown in FIG. 12. Additionally, as illustrated in FIG. 16, it is assumed that a communication error was selected as the error type to be displayed for the setting distribution task, and that an error other than a communication error was selected as the error type to be displayed for the address book distribution task.

In step S1001, the target devices and task information for the batch processing task are acquired. In this case, it is assumed that the target devices are Device 1 and Device 2, both of which had tasks that were terminated due to errors, where the setting value distribution task ended due to a communication error (the authentication information could not be read), and the address book distribution task ended due to another error (a setting error on the printer side). In step S1401, it is determined that the status of the task is a termination due to an error and that an error type has been selected. In step S1402, the processing of steps S1501 to S1505 is performed for each device.

First, processing is performed for Device 1. In step S1501, it is determined that the selected error types have occurred in Device 1, since a communication error occurred in the setting distribution task and an error other than a communication error occurred in the address book distribution task. Then, in steps S1502 and S1503, Device 1 is displayed together with the error details. Next, in steps S1504 and S1505, the processing target is switched to Device 2. In steps S1501 to S1503, the same processing as that for Device 1 is performed for Device 2. In step S1504, it is determined that Device 2 is the last device, and the processing ends. As a result of the above processing, the task execution result details screen 1600 (FIG. 16) for the batch processing task corresponding to the selected error types is displayed.

In step S1501, it is determined whether or not errors of the selected error types have occurred in all of the plurality of tasks. In a case in which the setting value distribution task did not result in a communication error or the address book distribution task did not result in an error other than a communication error, it is determined in step S1501 that the device is not a display target, and steps S1502 and S1503 are not executed, and therefore the device is not displayed. Note that, although in the present embodiment an example has been explained in which, in a batch processing task including a plurality of tasks, only devices for which all of the errors that occurred match all of the error types that were selected for the respective tasks match are displayed, the present invention is not limited thereto. In a case in which even one of the error types selected for the respective tasks matches the type of an error that has occurred, the device may be displayed in the list display. For example, it is assumed that a communication error has been selected as the error type to be displayed for the setting distribution task, and that an error other than a communication error has been selected as the error type to be displayed for the address book distribution task. In a case in which both the setting distribution task and the address book distribution task have resulted in communication errors, although the error type for the address book distribution task differs from the specified error type, the error type for the setting distribution task matches the specified error type, and therefore, the device may be displayed in the detail list 1601.

By this series of processing, even in a case in which the task is a batch processing task, it becomes possible, on the task execution result detail screen that can be confirmed from the task execution history, to select an error type and to display only devices in which a specific error corresponding to the selected error type has occurred. As a result, it becomes possible to display only the devices in which a specific error has occurred in a list, thereby improving the ease with which the user can grasp the error status, and enhancing the user convenience.

Note that the present disclosure may be applied to a system configured by a plurality of devices (for example, a host computer, an interface device, a reader, a printer, and the like) or may be applied to an apparatus configured by a single device (for example, a copying machine, a facsimile device, and the like). Additionally, the object of the present disclosure is also achieved by supplying to a system or an apparatus a recording medium in which a program code for realizing the functions of the embodiment described above is recorded, and by causing a computer of the system or the apparatus to read and execute the program code stored in the recording medium. In this case, the program code that has been read out from the recording medium itself realizes the functions of the embodiments described above, and the program code itself and the recording medium storing the program code constitute the present disclosure.

Additionally, the present disclosure also includes a case in which an operating system (OS) and the like operating on a computer performs part or all of the actual processing based on instructions of the program code, and the functions of the embodiments described above are realized by the processing. Furthermore, the present disclosure is also applied to a case in which the program code that has been read out from the recording medium is written into a memory that is provided in a function expansion card inserted into the computer or a function expansion unit that is connected to the computer. In that case, based on instructions of the written program code, a CPU and the like provided in the function expansion card or the function expansion unit performs part or all the actual processing, and the functions of the embodiments described above are realized by the processing.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-174255, filed October 3 2024, which is hereby incorporated by reference herein in its entirety.

What is claimed is:

1. A management apparatus that manages network devices via a network, the management apparatus comprising:
a memory storing instructions; and
a processor executing the instructions causing the management apparatus to:
execute a task on a network device selected from among network devices to be managed; and
control display of an execution result of the task;
wherein, in the display of the execution result of the task, for a task that has ended due to an error, a detailed screen is displayed that displays for each of the network devices, in a list, information indicating a network device that is the target of the task, an error type, and detailed error information.

2. The management apparatus according to claim 1,wherein, in a case in which a task that has ended due to an error is a batch processing task that collectively processes a plurality of tasks, in the display of the execution result of the task, each task included in the batch processing task, as well as the error type and the detailed error information for each of the tasks are displayed.

3. The management apparatus according to claim 1, wherein, in a case in which selection of an error type is received from a user on the detailed screen, the processor displays, on the detailed screen, in a list, network devices for which the error type matches the selected error type.

4. The management apparatus according to claim 1, wherein the detailed error information is information indicating at least one of a cause of the error, a component in which the error has occurred, and a recommended action for resolving the error.

5. The management apparatus according to claim 1, wherein the network device is an image processing apparatus having a printing function.

6. A control method for a management apparatus that manages network devices via a network, the method comprising:
executing a task on a network device selected from among network devices to be managed; and
controlling display of an execution result of the task,
wherein, in the display of the execution result of the task, for a task that has ended due to an error, a detailed screen is displayed that displays for each of the network devices, in a list, information indicating a network device that is the target of the task, an error type, and detailed error information.

7. A non-transitory storage medium storing a control program of a management apparatus that manages network devices via a network, the program causing a computer to perform each step of a control method of the management apparatus, the method comprising:
executing a task on a network device selected from among network devices to be managed; and
controlling display of an execution result of the task,
wherein, in the display of the execution result of the task, for a task that has ended due to an error, a detailed screen is displayed that displays for each of the network devices, in a list, information indicating a network device that is the target of the task, an error type, and detailed error information.
